(19) United States
(12) Patent Application Publication
(10) Pub. No.: US 2011/0267433 A1
(43) Pub. Date: Nov. 3, 2011

(54) IMAGE CAPTURING SYSTEM, IMAGE CAPTURING APPARATUS, AND IMAGE CAPTURING METHOD

(75) Inventors: Jonathan Richard THORPE, Winchester (GB); Hideki Ando, Tokyo (JP)

(73) Assignee: Sony Corporation, Tokyo (JP)

(21) Appl. No.: 13/081,842

(22) Filed: Apr. 7, 2011

(30) Foreign Application Priority Data
Apr. 30, 2010 (GB) 1007252.8

(51) Int. Cl. H04N 13/02

(52) U.S. Cl. 348/47; 348/46; 348/E13.074

(57) ABSTRACT

An image capturing system for capturing a stereo pair of images comprising a first image and a second image. The system comprises a first camera operable to capture the first image of the stereo pair of images, and a second camera operable to capture the second image of the stereo pair of images. The system further comprises a communication link operable to connect the first camera with the second camera so that the first camera can communicate with the second camera. The first camera is operable to transmit second camera control data to the second camera via the communication link so as to control functions of the second camera which relate to the capture of the second image.

### BACKGROUND OF THE INVENTION

1. Field of the Invention

The present invention relates to an image capturing system, image capturing apparatus, and image capturing method.

2. Description of the Prior Art

Recently, films for showing in a cinema on a projection screen are increasingly being made in a so-called three-dimensional (3D) format. Such a format may allow a viewer (user) to view a film such that the film appears three dimensional, for example if the viewer is wearing a suitable viewing device such as 3D glasses. Additionally, 3D televisions which can reproduce images in a 3D format are becoming increasingly available. Therefore, consumers are likely to want to be able to capture their own 3D images for playback on 3D televisions in a similar manner to conventional home videos. Other users such as professional video photographers, movie creators and the like are also becoming increasingly more interested in creating 3D images.

To create an illusion that an image is three-dimensional (3D), two slightly different images (typically called a stereo pair of images) may be viewed together so that one of the images is viewed by a user's left eye and the other image is viewed by a user's right eye. Provided that the two images correspond to two slightly different views of the same scene (for example each image in the pair being as if seen from the user's left eye and right eye respectively), the user's brain will fool the user into thinking that the pair of images is one three dimensional image when the images are viewed in a suitable manner.

In order to generate a stereo pair of images which, when viewed together in an appropriate manner, can be viewed as a three-dimensional image, typically a stereo pair of cameras is used to capture two images of a scene. The cameras of the stereo pair of cameras are typically spaced apart by a distance approximating an average distance between an adult human's eyes. However, differences between the cameras may mean that there may be other inter-image differences other than the desired horizontal offset. For example, a first camera for capturing the first image (left-hand image) may have a different colour sensitivity from a second camera for capturing the second image (right-hand image). The differences between the cameras used to capture the stereo pair of images can mean that, when the stereo pair of images is reproduced, the 3D effect may be impaired or cause headaches and/or nausea for the viewer. Additionally, differences in signal characteristics between the stereo pair of cameras may degrade results of disparity and/or depth estimation if the captured images are used to estimate disparity and/or depth using image processing operations.

The present invention seeks to alleviate or mitigate the above problems.

### SUMMARY OF THE INVENTION

In a first aspect, there is provided an image capturing system for capturing a stereo pair of images comprising a first image and a second image, the system comprising: a first camera operable to capture the first image of the stereo pair of images; a second camera operable to capture the second image of the stereo pair of images; a communication link operable to connect the first camera with the second camera so that the first camera can communicate with the second camera; in which the first camera is operable to transmit second camera control data to the second camera via the communication link so as to control functions of the second camera which relate to the capture of the second image.

In a second aspect, there is provided an image capturing apparatus for capturing a stereo pair of images comprising a first image and a second image, the apparatus comprising: an image capturing element operable to capture the first image of the stereo pair of images; a communication interface operable to receive, from a second camera, the second image of the stereo pair of images via a communication link; and a controller operable to generate second camera control data associated with control functions of the second camera which relate to the capture of the second image, in which the image capturing apparatus is operable to transmit the second camera control data to the second camera via the communication link so as to control the functions of the second camera which relate to the capture of the second image.

In a third aspect, there is provided an image capturing apparatus for capturing a first image of a stereo pair of images comprising the first image and a second image, the apparatus comprising: an image capturing element operable to capture the first image of the stereo pair of images; and a communication interface operable to transmit the first image of the stereo pair of images to a second camera via a communication link, the second image being associated with the second camera; in which: the communication interface is operable to receive, from the second camera via the communication link, camera control data associated with control functions of the image processing apparatus which relate to the capture of the first image; and the image capturing apparatus is operable to capture the first image in dependence upon the camera control data received from the second camera.

In a fourth aspect, there is provided an image capturing method for capturing a stereo pair of images comprising a first image and a second image, the method comprising: connecting a first camera with a second camera via a communication link so that the first camera can communicate with the second camera; capturing, at the first camera, the first image of the stereo pair of images; capturing, at the second camera, the second image of the stereo pair of images; transmitting second camera control data from the first camera to the second camera via the communication link so as to control functions of the second camera which relate to the capture of the second image.

Advantageously, the first camera can act as a master camera to control the second camera which acts as a slave camera. Therefore, any differences between the two cameras can be compensated for when capturing the stereo pair by appropriate generation of the second camera control data. This improves the quality of the captured stereo pair. Furthermore, such a system allows consumers to capture 3D images without the need for costly control units or other devices.

### BRIEF DESCRIPTION OF THE DRAWINGS

The above and other objects, features and advantages of the invention will be apparent from the following detailed description of illustrative embodiments which is to be read in connection with the accompanying drawings, in which:

FIG. 1 is a schematic diagram of a video camera in accordance with embodiments of the present invention;

FIG. 2 is a schematic diagram of a first configuration of a stereo pair of video cameras in accordance with embodiments of the present invention;

FIG. 3 is a schematic diagram of a second configuration of a stereo pair of video cameras in accordance with embodiments of the present invention;

FIG. 4 is a schematic diagram of a third configuration of a stereo pair of video cameras in accordance with embodiments of the present invention;

FIG. 5 is a schematic diagram of a fourth configuration of a stereo pair of video cameras in accordance with embodiments of the present invention;

FIG. 6 is a schematic diagram of a configuration of a stereo pair of video cameras for zoom control in accordance with embodiments of the present invention;

FIG. 7 is a schematic diagram of a representation of a disparity between a first image captured by a first camera of the stereo pair of video cameras and a second image captured by a second camera of the stereo pair of video cameras in accordance with embodiments of the present invention;

FIG. 8 is a schematic diagram of a first arrangement of the stereo pair of video cameras for detecting the disparity between the first image and the second image in accordance with embodiments of the present invention;

FIG. 9 is a schematic diagram of a second arrangement of the stereo pair of video cameras for detecting the disparity between the first image and the second image in accordance with embodiments of the present invention;

FIG. 10 is a schematic diagram of a third arrangement of the stereo pair of video cameras for detecting the disparity between the first image and the second image in accordance with embodiments of the present invention;

FIG. 11 is a schematic diagram of a fourth arrangement of the stereo pair of video cameras for detecting the disparity between the first image and the second image in accordance with embodiments of the present invention;

FIG. 12 is a schematic diagram of a fifth arrangement of the stereo pair of video cameras for detecting the disparity between the first image and the second image in accordance with embodiments of the present invention;

FIG. 13 is a schematic diagram of a sixth arrangement of the stereo pair of video cameras for detecting the disparity between the first image and the second image in accordance with embodiments of the present invention;

FIG. 14 is a schematic diagram of an arrangement of the stereo pair of video cameras for synchronising timing signals between the stereo pair of cameras in accordance with embodiments of the present invention;

FIG. 15 is a schematic diagram of an arrangement of the stereo pair of video cameras for audio capture in accordance with embodiments of the present invention;

FIG. 16 is a flow chart of an image capturing method in accordance with embodiments of the present invention;

FIG. 17 is a schematic illustration of a consumer video camera;

FIG. 18 is a schematic diagram of a stereo pair of consumer video cameras in accordance with embodiments of the present invention; and

FIG. 19 is a schematic diagram of a fifth configuration of a stereo pair of video cameras in accordance with embodiments of the present invention.

### DESCRIPTION OF THE PREFERRED EMBODIMENTS

An image capturing system, image capturing apparatus, and image capturing method are disclosed. In the following description, a number of specific details are presented in order to provide a thorough understanding of embodiments of the present invention. It will be apparent however to a person skilled in the art that these specific details need not be employed to practise the present invention. Conversely, specific details known to the person skilled in the art are omitted for the purposes of clarity in presenting the embodiments.

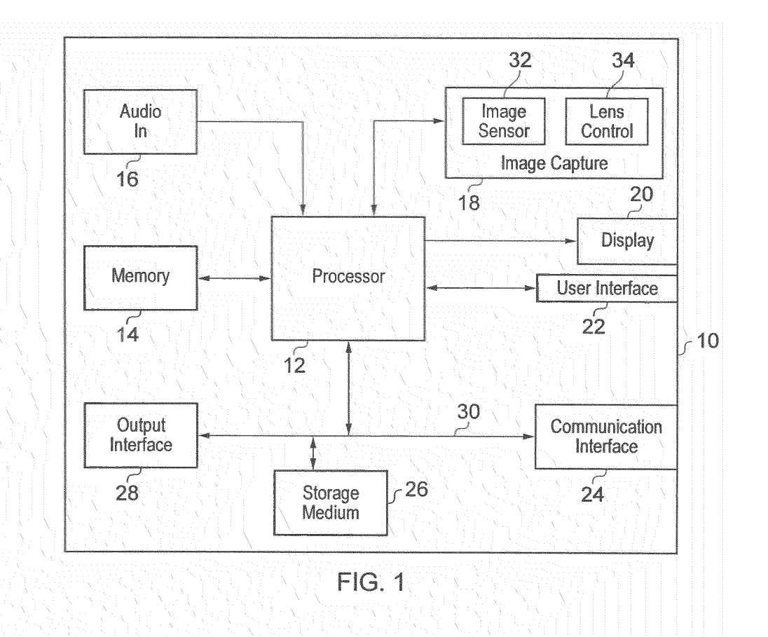

FIG. 1 is a schematic diagram of a video camera in accordance with embodiments of the present invention. In particular, FIG. 1 shows a video camera 10 which has similar components to a typical video camera known in the art. The video camera 10 comprises: a processor 12; a memory 14; an audio in unit 16; an image capture unit 18; a display 20; a user interface 22; a communication interface 24; a storage medium 26; and an output interface 28.

The camera 10 further comprises a data bus 30. The data bus 30 connects the output interface 28 with the communication interface 24 so that data can be passed between the output interface 28 and the communication interface 24. Additionally, the processor 12 is connected to the data bus 30 so that the processor 12 can transmit and/or receive data to/from the data bus 30. The storage medium 26 is connected to the data bus 30 so that the storage medium 26 can transmit and/or receive data to/from the data bus 30.

The storage medium 26 is operable to store media data such as audio/video (A/V) data captured by the camera 10. Additionally, the storage medium can store metadata related to the media data. However, it will be appreciated that the storage medium 26 could store any other suitable type of data as appropriate.

In embodiments, the storage medium 26 is a removable storage medium such as a re-writable DVD (RW-DVD), although it will be appreciated that any suitable removable storage medium such as DVD, Blu-ray disc, flash memory, and the like could be used. In other embodiments, the storage medium 26 is a hard disc drive or solid state drive (e.g. flash memory), although any other suitable storage medium could be used.

The memory 14 is operable to communicate bidirectionally with the processor 12. In embodiments, the memory 14 stores code for causing the processor 12 to implement functions of the video camera. Additionally, in some embodiments, the memory 14 can store audio visual data, although it will be appreciated that the memory 14 could store any suitable type of data. In embodiments, the memory 14 may act in cooperation with the processor 12 in any suitable way to provide functionality commonly known in the art of video cameras.

The audio in unit 16 enables the video camera 10 to capture sound. In embodiments, the audio in unit 16 comprises a microphone for capturing sound. However, in some embodiments, the audio in unit 16 comprises audio inputs to allow external devices such as external condenser microphones to be connected to the video camera 10. The audio in unit 16 is operable to communicate with the processor 12 so that audio data from the audio in unit 16 can be processed by the processor 12.

The image capture unit 18 is operable to capture one or more images so as to generate a sequence of video images. The image capture unit 18 is operable to communicate bidirectionally with the processor 12. For example, image data could be captured by the image capture unit 18 in accordance with image capture control data generated by the processor 12. The image data could then be processed by the processor 12 and stored to the storage medium 26. However, it will be appreciated that any other suitable method of capturing an image or sequence of video images could be used.

In embodiments, the image capture unit 18 comprises an image sensor 32 and a lens control unit 34. In embodiments, the image sensor 32 comprises a charge coupled device (CCD) for generating image data relating to a captured image, although any other suitable image sensor (such as a complementary metal oxide semiconductor (CMOS) sensor) could be used.

The lens control unit 34 is operable to control physical parameters of a camera lens of the video camera 12. For example, the lens control unit 34 could control the aperture, and zoom of the camera lens in response to appropriate control signals from the processor 12. However, it will be appreciated that any other suitable method of controlling the lens could be used.

The display 20 allows an operator to view the captured image as well as other functions of the camera 10 in dependence upon display control signals generated by the processor 12. In embodiments, the display 20 is a conventional LCD camera viewfinder typically found on consumer video cameras. However, it will be appreciated that the display 20 could be mounted in any suitable manner on the camera 10 for viewing by an operator or viewer. In some embodiments, the display 20 comprises a touch panel such as a capacitive touch array known in the art which acts as a user interface to the camera 10.

The user interface 22 allows an operator to control the functionality of the camera 10 in a similar manner to user interfaces typically found on consumer video cameras. In some embodiments, the user interface 22 is operable to cooperate with the display 20 to provide touch screen functionality for controlling the video camera 10 as mentioned above.

The communication interface 24 is operable to transmit data to and/or receive data from another video camera via a communication link. In some embodiments, the communication interface is operable to communicate with one or more other devices such as a personal computer (PC). For example, the communication interface 24 could comprise an i.LINK port to communicate with a PC to upload audio and visual content to the PC. However, it will be appreciated that the communication interface 24 could allow communication with one or more other devices in any suitable way. The functionality of the communication interface 24 will be described in more detail later below.

The output interface 28 is operable to output data such as media data, metadata and the like for use by other devices. For example, the output interface 28 could output an A/V stream for monitoring by an audio/video mixing facility. However, it will be appreciated that any suitable data could be output via the output interface 28.

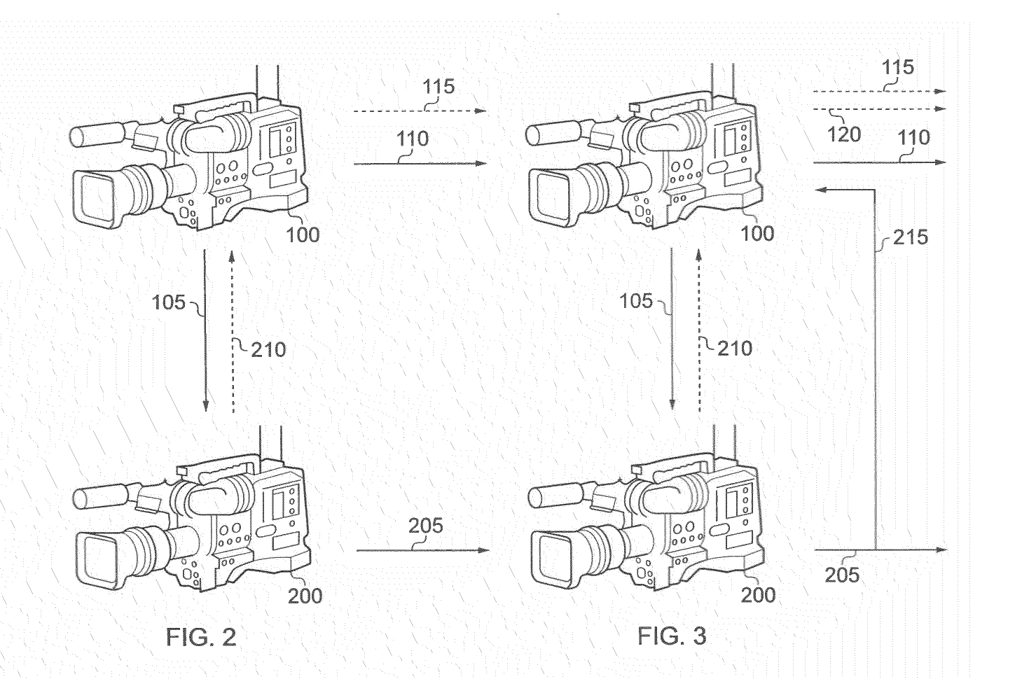

The use of a stereo pair of video cameras to capture a stereo pair of images will now be described with reference to FIGS. 2 to 16.

As mentioned above, to create an illusion that an image is three-dimensional (3D), two slightly different images (e.g. a first image of a stereo pair of images and a second image of a stereo pair of images) may be viewed together so that one of the images is viewed by a user's left eye and the other image is viewed by a user's right eye. Provided that the two images correspond to two slightly different views of the same scene (for example each image in the pair being as if seen from the user's left eye and right eye respectively), the user's brain will fool the user into thinking that the pair of images is one three-dimensional image when the images are viewed in a suitable manner. An object within the images will appear at an apparent depth from the display which is dependent upon an offset amount between the left-hand image corresponding to that object and the right-hand image corresponding to that object.

In order to try and ensure that each eye sees the image that is intended to be viewed by that eye, many techniques are known. In some techniques, each image of the stereo pair can be reproduced in such a way so as to be separable from the other image. For example, the left-hand image could be displayed next to the right-hand image and a suitable viewer such as a stereoscope used to view the images. This method of displaying the images was used in the earliest forms of 3D images.

Alternatively, light relating to a left-hand image intended to be viewed by the left eye may be circularly polarised in a clock-wise direction, whilst light relating to a right-hand image intended to be viewed by the right eye may be circularly polarised in an anti-clockwise direction. The left-hand image and right-hand image are then superimposed on each other. By wearing appropriate glasses in which a polarisation of each lens corresponds with the desired image to be viewed, the correct image for each eye will be viewed by the user. Many other systems of displaying and viewing the images are also known such as linear polarisation, coloured filters (e.g. red/cyan anaglyph), chromadepth, and anachrome; these systems require a user to wear an appropriate pair of glasses.

Other techniques involve alternately displaying the left-hand image and right-hand image. For example, the left-hand and right-hand images can be displayed alternately at a rate which corresponds to a frame rate for each image which is faster than a user's persistent vision (typically 24 frames per second). In other words a sequence of frames comprising alternate left-hand (L) and right-hand (R) images (e.g. LRLRLRLRLR) could be displayed at a frame rate of 60 frames per second (i.e. 30 frames per second for each image). The user can then view the images using an appropriate pair of 3D glasses which alternately block the corresponding left-hand image or right-hand image so that the correct image is viewed by the correct eye. In this technique, the 3D glasses may be operable to alternately obscure the right lens and the left lens in synchrony with the displayed images so that the left eye sees only the left images and the right eye sees only the right images. 3D glasses for viewing the alternate left-hand and right-hand images are typically called “shutter glasses” because the lenses act as shutters to alternately blank or obscure the left-hand and right-hand images.

Here, the term “viewed together” should be understood to mean that the left-hand image and the right-hand image can be viewed simultaneously, alternately, or in any other suitable way such that a user perceives a three-dimensional effect. In other words, the three-dimensional representation can be thought of as comprising a stereo pair of images, in which the stereo pair comprises the left-hand image and the right-hand image.

As mentioned above, in order to generate a stereo pair of images which, when viewed together in an appropriate manner, can be viewed as a three-dimensional image, typically a stereo pair of cameras is used to capture two images of a scene. The cameras of the stereo pair of cameras are typically spaced apart by a distance approximating an average distance between an adult human's eyes. However, differences between the cameras may mean that there may be other inter-image differences other than the desired horizontal offset. For example, a first camera for capturing the first image (left-hand image) may have a different colour sensitivity from a second camera for capturing the second image (right-hand image). Therefore, when the stereo pair of images is reproduced, the 3D effect may be impaired or cause headaches and/or nausea for the viewer.

To address this, the cameras could be controlled by an external unit to try and equalise the differences between the two cameras. However, this can be costly as well as difficult for a consumer to operate. Furthermore, this may not be desirable to consumers because they may have to purchase another device in order to capture 3D images satisfactorily.

Therefore, in embodiments, a first camera is operable to transmit second camera control data to a second camera via a communication link so as to control functions of the second camera which relate to the capture of the second image. Accordingly, the first camera can control operation of the second camera without the need for a separate control unit.

FIG. 2 is a schematic diagram of a first configuration of a stereo pair of video cameras in accordance with embodiments of the present invention. In the first configuration, the system comprises a first camera 100 which acts as a master camera, and a second camera 200 which acts as a slave camera. In embodiments, the first camera 100 and the second camera 200 have similar elements and functionality as the video camera 10 described above.

The first camera 100 is operable to communicate bidirectionally with the second camera 200 via a communication link. In the first configuration, the first camera 100 is operable to transmit second camera control data to the second camera 200 via the communication link as indicated by the arrow 105. In embodiments, the second camera control data comprises metadata related to synchronisation of camera parameters such as zooming, aperture colour balance and the like. In response to the second camera control data, the second camera 200 can control the capture of the second image in dependence upon the second camera control data.

For example, the processor of the first camera 100 could generate the second camera control data to control the zooming of the second camera 200 so that the lens control unit of the second camera 200 controls the zoom of the second camera 200 in synchrony with the zoom of the first camera 100.

In the first configuration, the first camera 100 is operable to output audio/video data relating to the first image via its output interface as indicated by the arrow 110. Additionally, the second camera 200 is operable to output A/V data relating to the second image via its output interface as indicated by the arrow 205.

In embodiments, the first camera 100 is operable to generate first camera control data associated with control functions of the first camera 100, as well as being operable to generate the second camera control data. Therefore, the first camera 100 can respond to the first camera control data whilst simultaneously controlling the second camera 200 using the second camera control data.

In some embodiments, the second camera is operable to transmit second camera status data to the first camera 100 via the communication link, as indicated by the dashed arrow 210. The second camera status data is indicative of a status of a control function of the second camera. The first camera 100 can then generate the second camera control data based on the second camera status data, for example as a feedback loop for controlling zoom operations. More generally, in embodiments, the processor of the first camera 100 is operable to generate the second camera control data in dependence upon the second camera status data received from the second camera.

Additionally, in some embodiments, the first camera 100 is operable to output synchronisation monitoring data via its output interface as indicated by the dashed arrow 115. The synchronisation monitoring data relates to the second camera status data and can be used during editing of the images.

In embodiments, the communication link is a wired link such as Firewire, or USB2 although any suitable wired link could be used. However, in other embodiments, the communication link is a wireless link, with the communication taking place using a wireless communication protocol. In some embodiments, the communication link allows transfer of data using a standard protocol such as internet protocol (IP) or ethernet. In other embodiments, a dedicated communication protocol is used which is specific to the cameras being used. However, it will be appreciated that any other suitable communication link which uses any other suitable communication protocol could be used.

FIG. 3 is a schematic diagram of a second configuration of a stereo pair of video cameras in accordance with embodiments of the present invention. The second configuration is similar to the first configuration described above with reference to FIG. 2. However, in the second configuration, the second camera 200 is operable to transmit audio/video data to the first camera 100 via the communication link as indicated by the arrow 215. This advantageously allows the first camera 100 to monitor the audio/video signal of the second camera 200 so that the first camera 100 can adjust its own settings such as audio levels, zoom setting and the like, so as to try and match those of the second camera 200. This helps improve the consistency between the first image and the second image so as to help improve the overall 3D effect when the first image and second image are viewed together.

Additionally, in some embodiments, the first camera 100 is operable to generate the second camera control data so that the second camera 200 can manipulate its output to have similar or the same parameters as that of the first camera 100. In other words, the second camera control data can act as a feedback adjustment signal for controlling the second camera 200.

In the second configuration, the first camera 100 is operable to output camera angle setup data (as indicated by the dashed arrow 120). The camera angle setup data can be generated by the first camera 100 using the A/V data received from the second camera 200. For example, the camera angle setup data could comprise difference data relating to the horizontal and vertical displacement of the first image with respect to the second image. As another example, the camera angle setup data could allow the operator to view the first image overlaid on top of the second image. The operator could then physically manipulate the second camera 200 and/or the first camera 100 to achieve the desired camera angle or alignment between the two cameras.

In some embodiments, each camera comprises a level detector operable to detect an orientation of the camera. In some embodiments the level detector is operable to detect whether the camera is level (e.g. whether a horizontal axis of the image sensor is parallel to the horizon) using known techniques and output level data to the display. In other words, the level detector is operable to detect the inclination of the camera.

The user can then compare the output level data as displayed on the display and physically manipulate the first camera 100 and/or the second camera 200 to achieve the desired camera angle or alignment between the two cameras. However, it will be appreciated that any other suitable technique could be used.

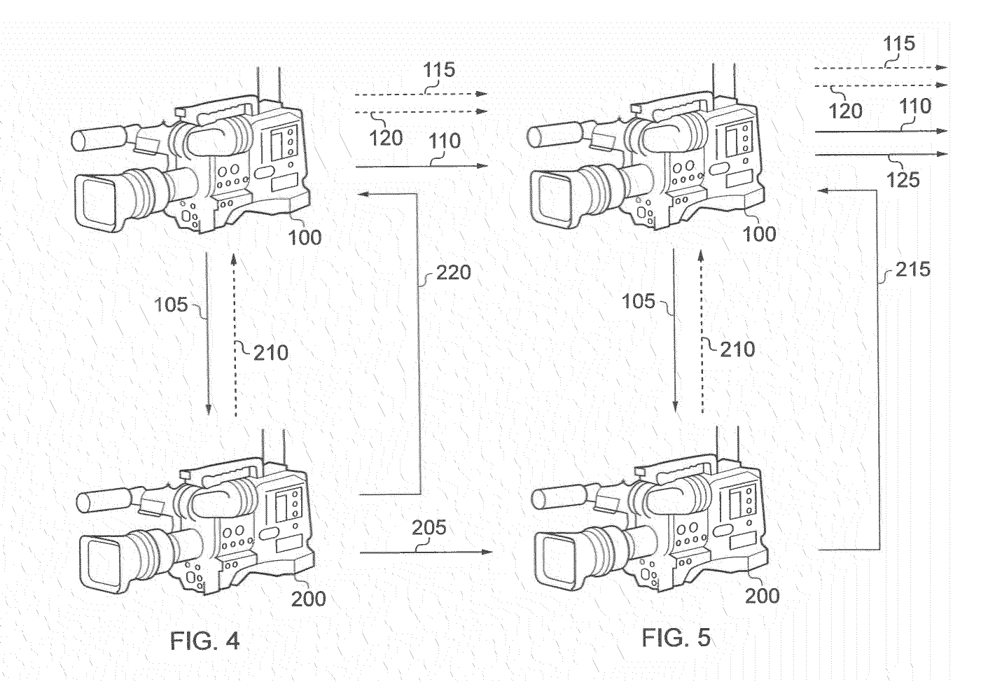

FIG. 4 is a schematic diagram of a third configuration of a stereo pair of video cameras in accordance with embodiments of the present invention. The third configuration is similar to the first configuration and second configuration as described above. However, in the third configuration, the second camera 200 is operable to transmit parameterised media metadata from the second camera 200 to the first camera 100 via the communication link as indicated by the arrow 220 in FIG. 4.

In embodiments, the parameterised media metadata relates to the media data captured by the second camera 200 such as the second image or audio data captured by the second camera 200. The media metadata is parameterised in order to reduce bandwidth and/or to reduce a signal processing load in the first camera 100.

For example, the parameterised media metadata could comprise key point descriptors generated by the second camera 200 by image analysis of the second image and/or sequence of video images captured by the second camera 200. In embodiments, the second camera 200 is operable to implement scale invariant feature transform (SIFT) and/or speeded up robust features (SURF) analysis of the sequence of video images captured by the second camera 200 so as to generate the key point descriptors. This will be described in more detail later below.

Additionally, in embodiments, the parameterised media metadata comprises audio frequency response data generated by the second camera 200 by carrying out known fourier analysis techniques on audio captured by the second camera 200. However, it will be appreciated that any suitable method for generating the parameterised media data could be used.

FIG. 5 is a schematic diagram of a fourth configuration of a stereo pair of video cameras in accordance with embodiments of the present invention. The fourth configuration is similar to the second configuration described above. However, in the fourth configuration, instead of the second camera 200 outputting the A/V stream captured by the second camera 200, the second camera 200 is operable to transmit the A/V stream to the first camera 100 via the communication link as indicated by the arrow 215.

The first camera 100 is operable to output a first A/V stream representing the left-hand image (as indicated by the arrow 110) and a second A/V stream representing the right-hand image (as indicated by the arrow 125). In some embodiments, the first camera 100 can carry out image processing operations on the A/V stream received from the second camera 200 so as to generate the second A/V stream 125.

For example, in response to camera status data comprising Gamma correction data received from the second camera 200 via the communication link (as indicated by the dashed arrow 210), the first camera 100 can carry out Gamma correction on the A/V stream received from the second camera 200 so as to generate the A/V stream 125.

By generating the second A/V stream based on the A/V stream received from the second camera, embodiments of the present invention reduce a processing load on any downstream editing units which may be used to edit the first A/V stream and the second A/V stream. Furthermore, this simplifies the editing process because the second A/V stream can be generated by the first camera 100 so that features of the second A/V stream (such as colour balance, audio levels etc.) can more closely match that of the first A/V stream. Furthermore, the second and fourth configurations allow the A/V stream received from the second camera 200 to be recorded to the storage medium of the first camera 100.

In some embodiments, the A/V stream from the first camera 100 and the A/V stream from the second camera 200 can be stored as a single file or single stream. However, in other embodiments, the A/V stream from the first camera 100 and the A/V stream from the second camera 200 can be stored as separate files or separate streams. However, it will be appreciated that the streams may be stored in any other suitable format.

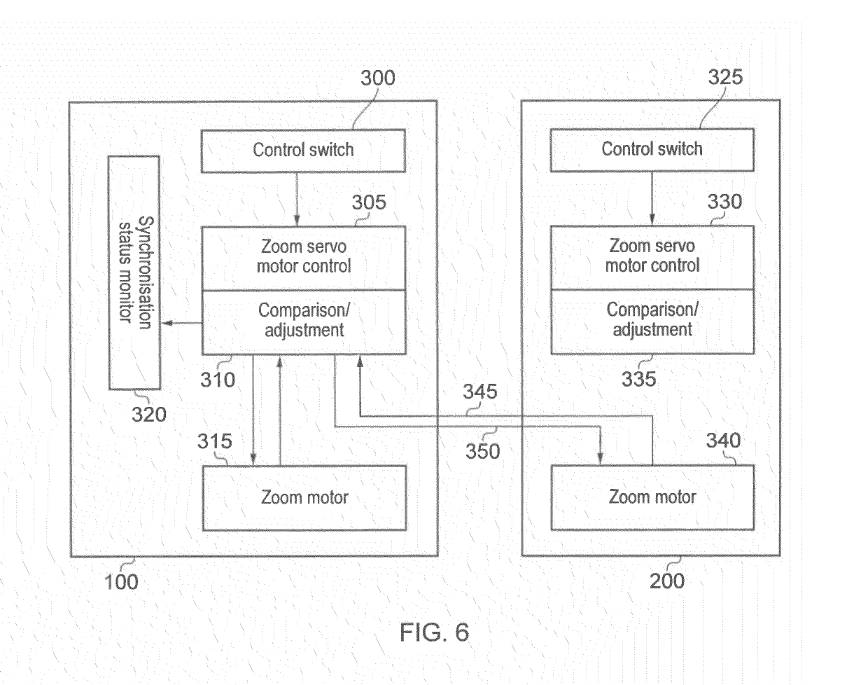

An example of zoom control in accordance with embodiments of the present invention will now be described with reference to FIG. 6.

FIG. 6 is a schematic diagram of a configuration of a stereo pair of video cameras for zoom control in accordance with embodiments of the present invention. In particular, FIG. 6 shows a schematic diagram of the first camera 100 and the second camera 200. The first camera comprises a control switch 300, a zoom servo motor control unit 305, a comparison/adjustment unit 310, a zoom motor 315, and a synchronisation status monitor unit 320. The functionality of the control switch 300, control unit 305, and comparison adjustment unit 310 can be implemented by the processor in cooperation with the image capture unit of the video camera 100. The processor of the video camera 100 can act as the synchronisation monitor unit 320.

The second camera comprises a control switch 325, a zoom servo motor control unit 330, a comparison/adjustment unit 335, a zoom motor 340, which have similar functionality to the corresponding elements in the first camera 100. However, in the second camera, the control switch 325, the zoom servo motor control unit 330, and the comparison/adjustment unit 335 are disabled so that the zoom motor 340 can operate under the control of the first camera 100. The zoom motor 340 is operable to cause the second camera to transmit second camera zoom motor status data from the second camera 200 to the first camera 100 via the communication link as indicated by the arrow 345. The zoom motor status data is indicative of a current zoom setting of the zoom motor 340. Additionally, the first camera 100 is operable to transmit zoom motor control data to the zoom motor 340 via the communication link (as indicated by the arrow 350) so as to control operation of the zoom motor 340.

In response to a suitable user input via the user interface of the first camera 100, the control switch 300 may activate a zoom operation, for example, to narrow the field of view and zoom in on an object as directed by the operator. The zoom servo motor control unit 305 then generates appropriate control signals to implement that zoom operation. The motor control unit 305 communicates with the comparison adjustment unit 310 so as to control the zoom motor 315 and the zoom motor 340.

On initiation of the zoom operation, the comparison adjustment unit 310 detects the current zoom setting of the zoom motor 340 based on the zoom motor status data. The adjustment unit 310 is operable to detect whether this corresponds to the zoom setting of the zoom motor 315. The motor control unit 305 can then generate appropriate control signals to control the zoom motor 315 and/or the zoom motor 340 so that the zoom setting of the zoom motor 315 substantially matches that of the zoom motor 340.

On further zooming operations, the motor control unit 305 can generate appropriate control signals so that the zoom motor 315 and the zoom motor 340 operate in synchrony. In other words, the first camera 100 controls the zooming operation of the second camera 200.

In embodiments, the status monitor 320 is operable to generate status monitor data which is indicative of a degree of synchronisation between the zoom motor 315 and the zoom motor 340. The status monitor data can be associated with the A/V data generated by the first and second cameras so that an editor can tell whether the zoom operations were synchronised. This allows an editor to determine if a sequence of stereo pairs of video images is likely to provide a satisfactory 3D effect. This is especially useful is there is some degree of latency when initially synchronising the zoom motors or during image capture.

In some embodiments, the adjustment unit 310 is operable to detect a degree of latency in the communication link using known techniques and generate control signals which compensate for the latency in the communication link so as to try and keep the zoom motor 315 synchronised with the zoom motor 340.

It will be appreciated that although FIG. 6 shows an example of synchronising zoom motors during zoom operations, the techniques described above can be applied more generally to other operations such as aperture adjustment, focal length adjustment and the like. Furthermore, more than one camera could be synchronised to the camera 100.

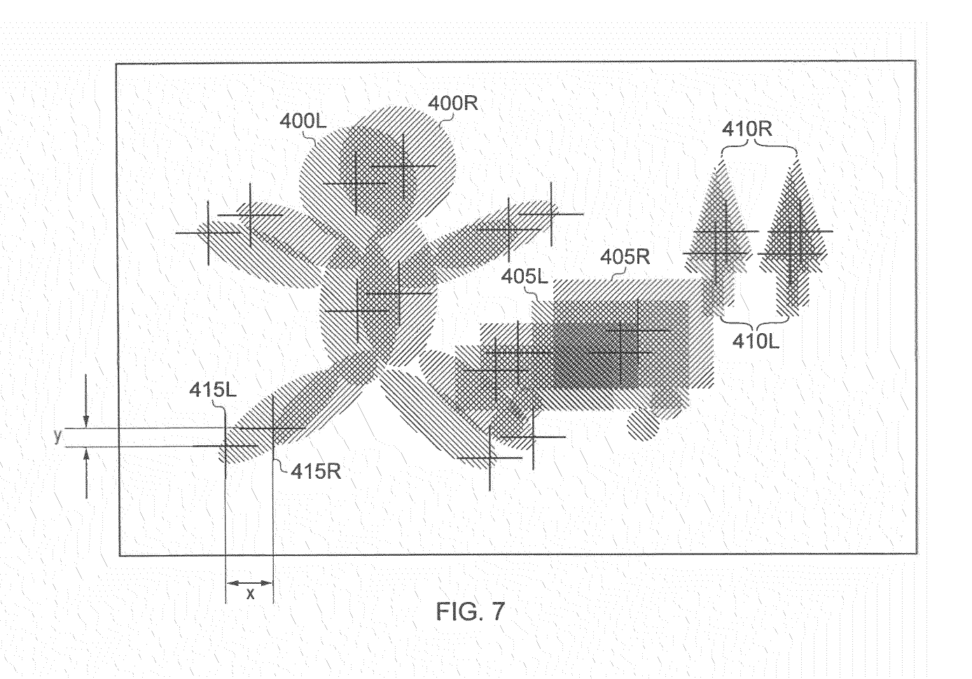

Embodiments of the present invention in which a disparity between the first image and the second image is detected will now be described with reference to FIG. 7. In some embodiments, the first camera 100 is operable to detect a displacement between a first image feature in the first image and a second image feature in the second image. This will now be described in more detail below.

FIG. 7 is a schematic diagram of a representation of a disparity between a first image captured by a first camera of the stereo pair of video cameras and a second image captured by a second camera of the stereo pair of video cameras in accordance with embodiments of the present invention.

In particular, FIG. 7 shows a left-hand image (indicated by the diagonal downwards shading from left to right) comprising image features corresponding to a person 400L, a van 405L and trees 410L. Additionally, FIG. 7 shows a right-hand image (indicated by the diagonally upwards shading from left to right) comprising images features corresponding to the person 400R, the van 405R and the trees 410R. In other words, the left-hand image (first image) and the right-hand image (second image) correspond to a stereo pair of images of the same scene.

In embodiments, the first camera 100 and/or the second camera 200 are operable to carry out SURF or SIFT analysis on the left-hand and right-hand images so as to detect keypoints which are indicative of identifying features of images features. However, any other suitable keypoint detection method could be used.

For example, a keypoint 415L of the left-hand image and a keypoint 415R may be identified, which correspond to an end of the person's leg. However, it will be appreciated that any number of keypoints could be detected. By comparison of the keypoints of the left-hand image and the keypoints of the right-hand image, the first camera 100 can detect a relative displacement between the first image (left-hand image) and the second image (right-hand image). As an example, with reference to the keypoint 415L and the keypoint 415R, the processor of the first camera may detect a horizontal displacement x and a vertical displacement y.

In embodiments, the detected horizontal displacement may be used to generate horizontal displacement data indicative of the horizontal displacement. Additionally, the detected vertical displacement may be used to generate vertical displacement data indicative of the vertical displacement. This advantageously allows further image processing steps to be carried out such as reduction of vertical displacement. Accordingly, by reducing the vertical displacement, the quality of the 3D experience for the viewer can be improved.

In some embodiments, the first camera 100 is operable to combine the first image with the second image so that the first image can be distinguished from the second image. For example, the first camera 100 could apply a blue filter to the first image and a red filter to the second image, in a similar manner to generating images for anaglyph display. The first camera 100 is operable to cause the combined image to be displayed on the display of the first camera 100 (and/or the second camera 200 as appropriate). The user can then visually compare the first image and the second image so they can recognise any disparities (e.g. vertical and horizontal displacement) between the two images. The user could then physically adjust the positions of the cameras accordingly, for example to achieve a desired horizontal and vertical displacement. This advantageously reduces processing resources because techniques such as SURF and SIFT can be computationally expensive. Additionally, other techniques for detecting the disparity between the first image and the second image could be used such as edge detection techniques. However, it will be appreciated that any suitable technique could be used.

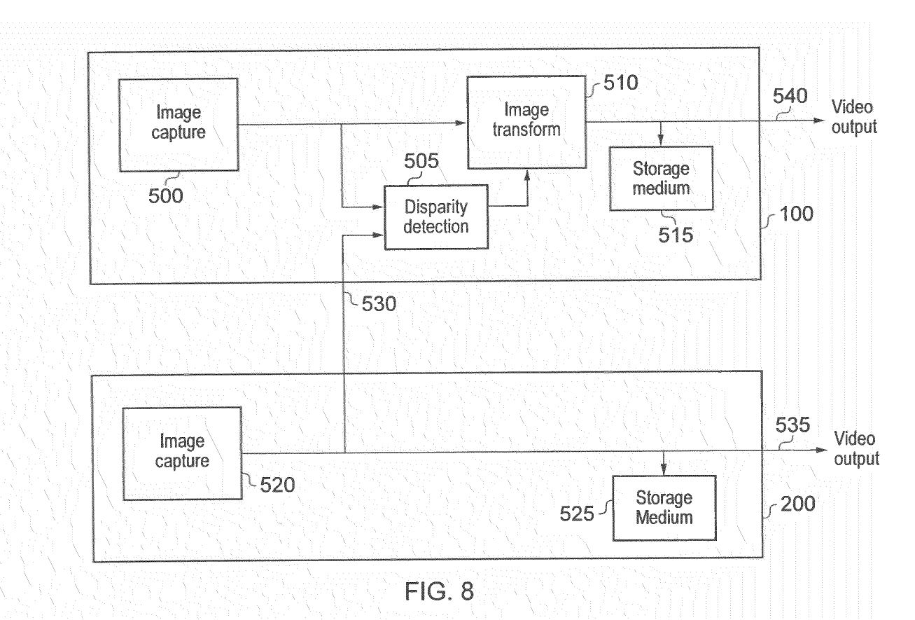

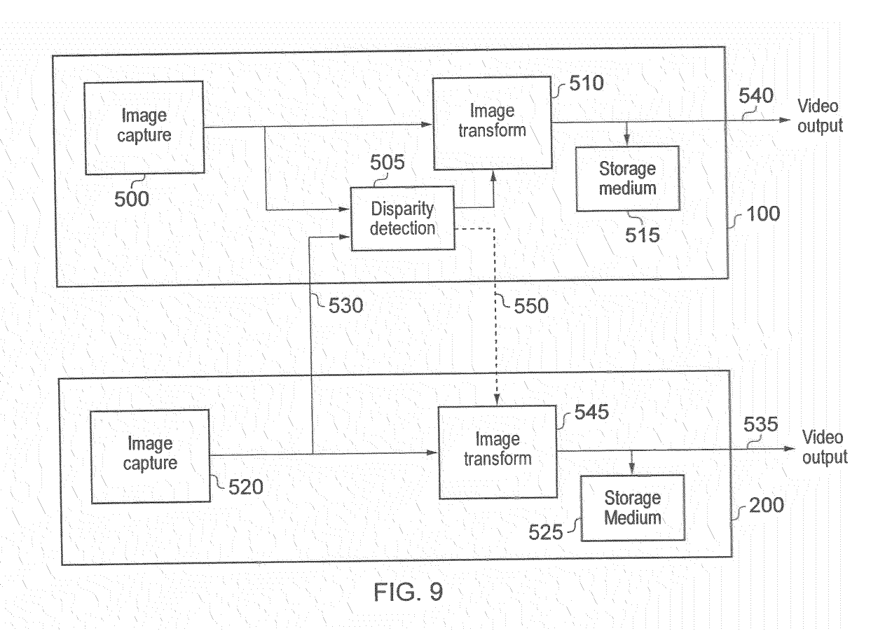

Embodiments of the present invention in which disparity (displacement) is detected between the first image and the second image will now be described with reference to FIGS. 8 to 13.

FIG. 8 is a schematic diagram of a first arrangement of the stereo pair of video cameras for detecting the disparity between the first image and the second image in accordance with embodiments of the present invention.

In particular, FIG. 8 shows the first camera 100 and the second camera 200. In the first arrangement, the first camera comprises an image capture unit 500 which functions in a similar manner to the image capture unit 18 described above with reference to FIG. 1. The first camera 100 further comprises; a disparity detection unit 505 which is implemented by the processor of the first camera 100; an image transform unit 510 which is implemented by the processor of the first camera 100; and a storage medium 515 (similar to the storage medium 26 described above). Other elements of the first camera 100 have not been shown in FIG. 8 to simplify the understanding of the figure.

In the first arrangement, the second camera comprises: an image capture unit 520 which functions in a similar manner to the image capture unit 18 described above with reference to FIG. 1; and a storage medium 525 (similar to the storage medium 26 described above). Other elements of the second camera 100 have not been shown in FIG. 8 to simplify the understanding of the figure.

In the first arrangement, the image capture unit 500 captures the first image and transmits data relating to the first image to the disparity detection unit 505 and the image transform unit 510. The image capture unit 520 of the second camera 200 captures the second image and transmits data relating to the second image to the disparity detection unit 505 of the first camera via the communication link (as indicated by an arrow 530). The second camera 200 is operable to output the second image as a video output signal 535 via the output interface of the second camera 200. Additionally, the second camera 200 is operable to store the second image to the storage medium 525.

The disparity detection unit 505 detects the disparity between the first image and the second image and outputs a disparity difference signal to the image transform unit 510. The image transform unit 510 applies an image transformation to the first image and outputs a video output signal 540 via the output interface of the first camera 100. Additionally, in embodiments, the first camera 100 is operable to store the video output signal 540 to the storage medium 515.

In embodiments, the disparity detection unit 505 is operable to detect differences between the first image and the second image. For example, the detection unit 505 could detect the vertical displacement and cause the image transform unit 510 to reduce the vertical displacement to zero. As another example, the disparity detection unit 505 could detect an average brightness level of the first image and an average brightness level of the second image and detect a difference between the two brightness levels. The image transform unit 510 could then adjust the brightness level of the first image so that the first image and the second image have the same average brightness level as each other. However, it will be appreciated that any other suitable image disparity could be detected and adjusted as appropriate.

FIG. 9 is a schematic diagram of a second arrangement of the stereo pair of video cameras for detecting the disparity between the first image and the second image in accordance with embodiments of the present invention. The second arrangement is similar to the first arrangement. However, in the second arrangement, the second camera 200 comprises an image transform unit 545.

In the second arrangement, the disparity detection unit 505 is operable to transmit disparity data to the image transform unit 545 via the communication link as indicated by the dashed line 550. The image transform unit 545 is operable to apply image transform operations to the second image in a similar manner to the image transform unit 510. Therefore, the video output signal 535 can comprise an adjusted second image which more closely matches image attributes of the first image.

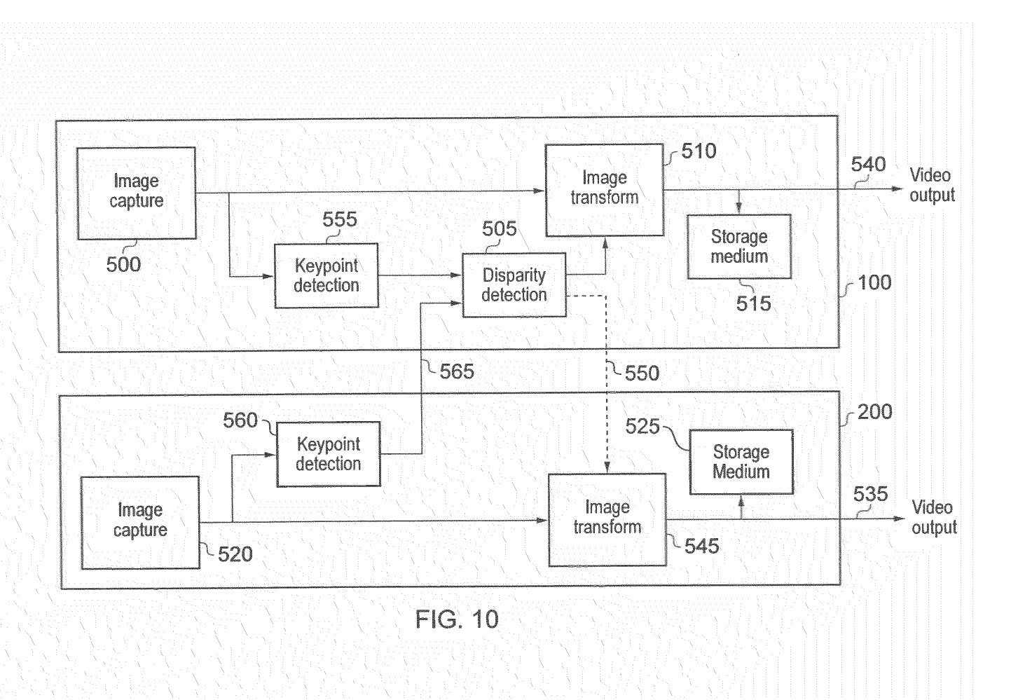

FIG. 10 is a schematic diagram of a third arrangement of the stereo pair of video cameras for detecting the disparity between the first image and the second image in accordance with embodiments of the present invention. The third arrangement is similar to the second arrangement. However, in the third arrangement, the first camera 100 comprises a keypoint detection unit 555 operable to detect a first set of one or more keypoints indicative of identifying features of a first image feature in the first image. Additionally, the second camera 200 comprises a keypoint detection unit 560 operable to detect a second set of one or more keypoints indicative of identifying features of a second image feature in the second image, in which the second image feature corresponds to the first image feature in the first image.

In embodiments, the keypoint detection unit 555 and the keypoint detection unit 560 are operable to detect keypoints using a SIFT or SURF technique implemented on the respective processors, although it will be appreciated that any other suitable keypoint detection method could be used.

The keypoint detection unit 560 is operable to transmit keypoint data relating to the second set of keypoints to the disparity detection unit 505 via the communication link (as indicated by the arrow 565). Additionally, the keypoint detection unit 555 is operable to transmit keypoint data relating to the first set of keypoints to the disparity detection unit 505.

The disparity detection unit 505 is operable to detect a relative displacement between the first image feature and the second image feature in dependence upon a comparison between the first set of keypoints and the second set of keypoints as indicated by the keypoint data.

In embodiments, the keypoint data comprises position data indicative of a position of the image feature within the second image and feature vectors associated with the image feature. However, the keypoint data could comprise any suitable data as appropriate. In some embodiments, the A/V data is not transmitted from the second camera 200 to the first camera 100. By transmitting the keypoint data without the A/V data, bandwidth requirements for the communication link can be reduced.

The image transform unit 510 is operable to carry out image transform operations on the first image in dependence upon the disparity data generated by the disparity detection unit 505 so as to generate the video output data 540. The video output data 540 can be stored to the storage medium 515.

Additionally, in some embodiments, the image transform unit 545 is operable to carry out image transformations to the second image in dependence upon the disparity data received from the disparity detection unit 505 so as to generate the video output signal 535. In some embodiments, the video output signal 535 can be stored to the storage medium 525.

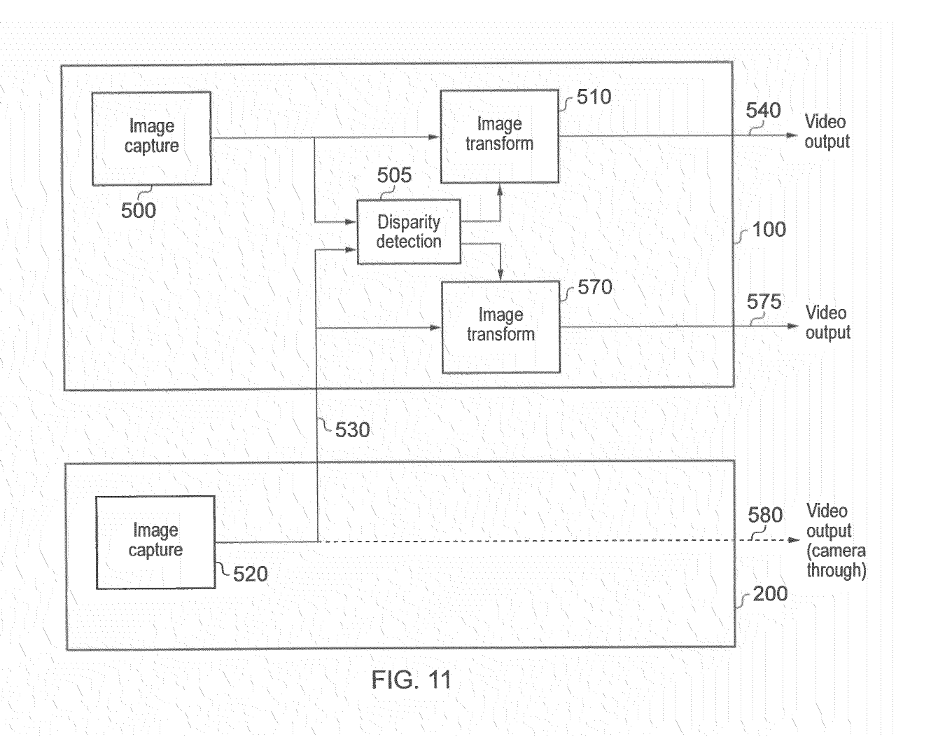

FIG. 11 is a schematic diagram of a fourth arrangement of the stereo pair of video cameras for detecting the disparity between the first image and the second image in accordance with embodiments of the present invention.

The fourth arrangement is similar to the first arrangement. However, in the fourth arrangement, the storage medium 515 and the storage medium 525 are not used. Additionally, in the fourth arrangement, the first camera 100 comprises a second image transform unit 570.

In the fourth arrangement, the image capture unit 520 is operable to transmit image data relating to the second image to the disparity detector 505 and the image transform unit 570 via the communication link. Additionally, the disparity detection unit 505 is operable to transmit disparity data to the image transform unit 570.

The image transform unit 510 can apply a suitable image transformation to the first image based on the disparity data so as to generate the video output signal 540. Additionally, the image transform unit 570 can apply a suitable image transformation to the second image received from the second camera based on the disparity data generated by the disparity detection unit 505 so as to generate a video output signal 575. The video output signal 575 represents the right-hand images, and the video output signal 540 represents the left-hand images.

In some embodiments, the camera 200 is operable to output a camera-through video output signal 580 which corresponds to the unaltered second image. This allows the second image to be monitored and compared to the video output signal 540 and the video output signal 575.

In some embodiments, the video output signal 540 and the video output signal 575 can be stored as a single file or single stream. However, in other embodiments, the video output signal 540 and the video output signal 575 can be stored as separate files or separate streams. However, it will be appreciated that the video output signals may be stored in any other suitable manner. Additionally, in some embodiments, the first camera 100 is operable to display the video output signal 540 and the video output signal 575 so that the right-hand images and the left-hand images can be distinguished from each other, for example, by anaglyph display or any other suitable technique.

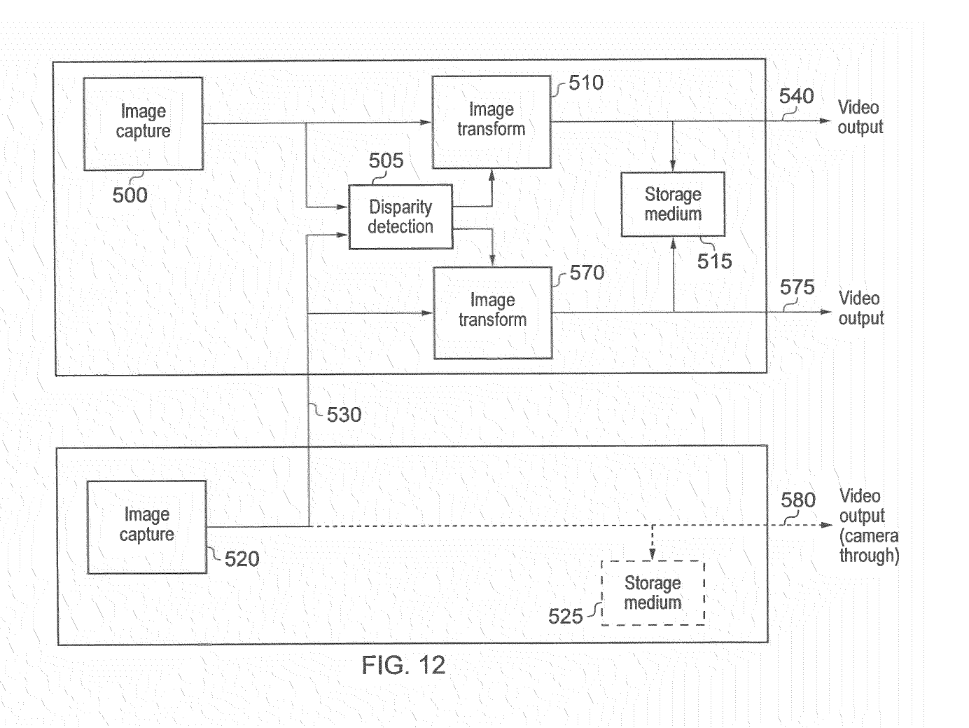

FIG. 12 is a schematic diagram of a fifth arrangement of the stereo pair of video cameras for detecting the disparity between the first image and the second image in accordance with embodiments of the present invention. The fifth arrangement is similar to the fourth arrangement. However, in the fifth arrangement, the storage medium 515 can be used to store the video output signal 540 and the video output signal 575. Additionally, in some embodiments, the storage medium 525 can be used to store the camera-through video output signal 580. As mentioned above, in some embodiments, the video output signal 540 and the video output signal 575 can be stored as a single file or single stream, or as separate files or separate streams.

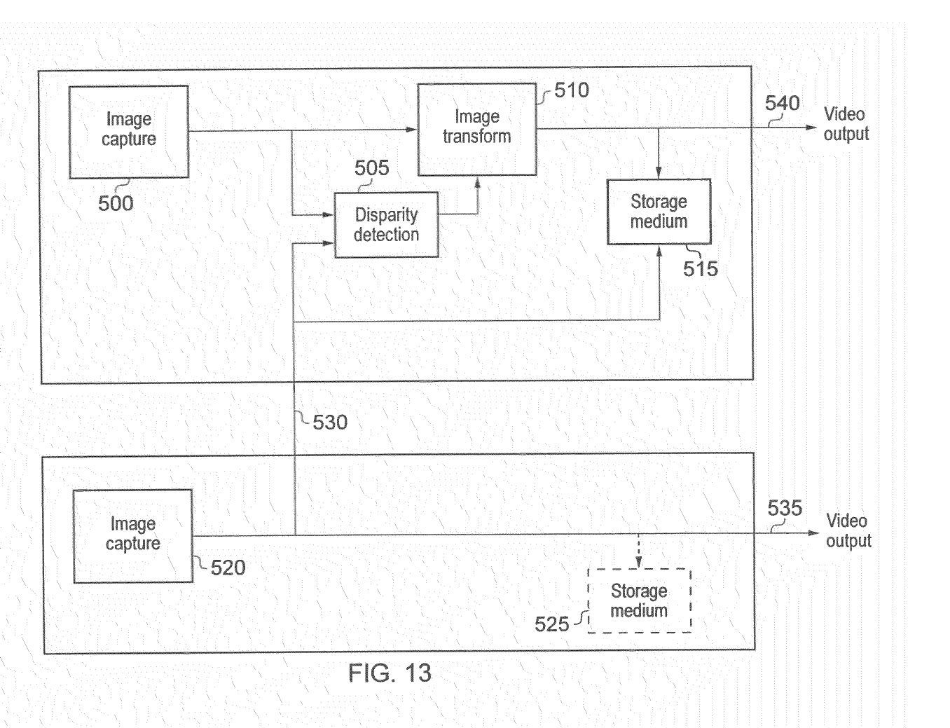

FIG. 13 is a schematic diagram of a sixth arrangement of the stereo pair of video cameras for detecting the disparity between the first image and the second image in accordance with embodiments of the present invention. The sixth arrangement is similar to the first arrangement. However, in the sixth arrangement, the second camera 200 is operable to transmit the video output signal 535 to the first camera via the communication link as indicated by the arrow 530. The first camera is operable to store the video output signal 535 to the storage medium 515 directly without any image transform operations being applied to the video output signal 535.

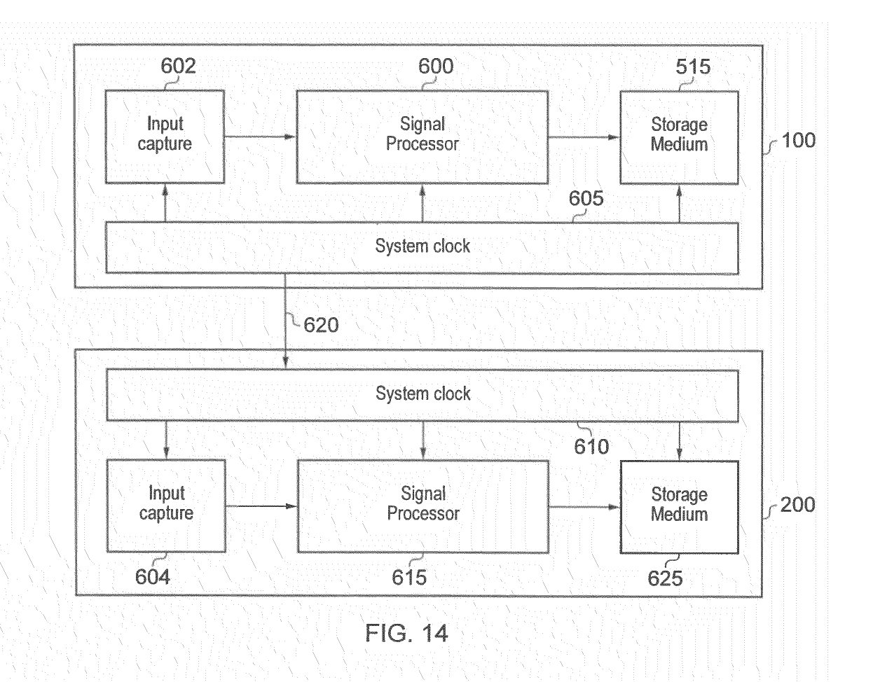

In embodiments, the first camera 100 is operable to cause the second camera 200 to synchronise a system clock of the second camera 200 with a system clock of the first camera in dependence upon timing reference data sent from the first camera 100 to the second camera 200 via the communication link. This will now be described in more detail with reference to FIG. 14.

FIG. 14 is a schematic diagram of an arrangement of the stereo pair of video cameras for synchronising timing signals between the stereo pair of cameras in accordance with embodiments of the present invention. In particular, FIG. 14 schematically shows the first camera 100 and the second camera 200. In the embodiment shown in FIG. 14, the first camera 100 comprises an input capture unit 602, a signal processor 600, the storage medium 515, and a system clock 605. The input capture unit 602 has similar functionality to the image capture unit 500 and can also capture audio data using known techniques.

The input capture unit 602, signal processor 600 and storage medium 515 are operable to receive timing reference data from the system clock 605 so that timing of data processing operations such as read/write operations to the storage medium 515 can be synchronised between input capture unit 602, the signal processor 600 and the storage medium 515. The input capture unit 602 is operable to transmit image data to the signal processor 600. The signal processor is operable to transmit processed image data to the storage medium 515 for storage. Other elements of the first camera 100 are not shown in FIG. 14 for the sake of clarity.

The second camera 200 comprises a system clock 610, an input capture unit 604, a signal processor 615, and the storage medium 525. The input capture unit 604 has similar functionality to the image capture unit 520 and can also capture audio data using known techniques. The input capture unit 604, signal processor 615 and storage medium 525 are operable to receive timing reference data from the system clock 610 so that timing of data processing operations such as read/write operations to the storage medium 525 can be synchronised between input capture unit 604, signal processor 615 and storage medium 525. The input capture unit 604 is operable to transmit image data to the signal processor 615. The signal processor 615 is operable to transmit processed image data to the storage medium 625 for storage. Other elements of the second camera 200 are not shown in FIG. 14 for the sake of clarity.

In embodiments, the first camera 100 is operable to transmit timing reference data generated by the system clock 605 to the second camera 200 via the communication link (as indicated by the arrow 620). The system clock 610 of the second camera 200 is operable to synchronise its timing reference data to the timing reference data generated by the system clock 605 in dependence upon the timing reference data generated by the system clock 605. Therefore, the system clocks of the first camera 100 and the second camera 200 can be synchronised. Accordingly, image capturing operations such as frame rate timing can be synchronised so that the first image and the second image are captured at substantially the same time as each other. It will be appreciated that the synchronisation of timing reference data could be applied to more than two cameras with the first camera 100 acting as a master camera, although any other camera could act as the master camera.

Additionally, in some embodiments audio timing data may be synchronised between the first camera 100 and the second camera 200 in a similar manner to that described with reference to frame rate timing, and system clock synchronisation.

In some embodiments, the first camera is operable to generate synchronisation data and transmit the synchronisation data to the second camera 200 via the communication link. The synchronisation data allows the second camera 200 to synchronise its functions with those of the first camera 100.

For example, the synchronisation data could relate to camera parameters such as zoom (focal length), camera angle, camera direction, scan timing (and/or frame rate), lens aperture, and shutter speed, although any other suitable camera parameters could be used.

As another example, the synchronisation data could relate to signal quality of the captured images such as gain, exposure, gamma, white balance, colour temperature, audio level, audio equalisation and the like, although the synchronisation data could relate to any other suitable aspect of signal quality as appropriate.

As a further example, the synchronisation data could relate to operation of the cameras such as record start, pause, stand-by, timecode metadata, error notification metadata (e.g. low battery, storage medium full etc.) and the like, although it will be appreciated that the synchronisation data could relate to any suitable operation of the cameras. Additionally, the synchronisation data could comprise file name synchronisation data so that a media stream generated by the first camera 100 can be associated with the corresponding media stream generated by the second camera 200. In the embodiments where the A/V content is stored as a single file or stream, the synchronisation data can assist during editing or monitoring of the A/V content.

Furthermore, it will be appreciated that any or all the examples of synchronisation data could be combined as appropriate to synchronise one or more cameras with a master camera using the synchronisation data transmitted from the master camera (e.g. the first camera 100) to other cameras via an appropriate communication link.

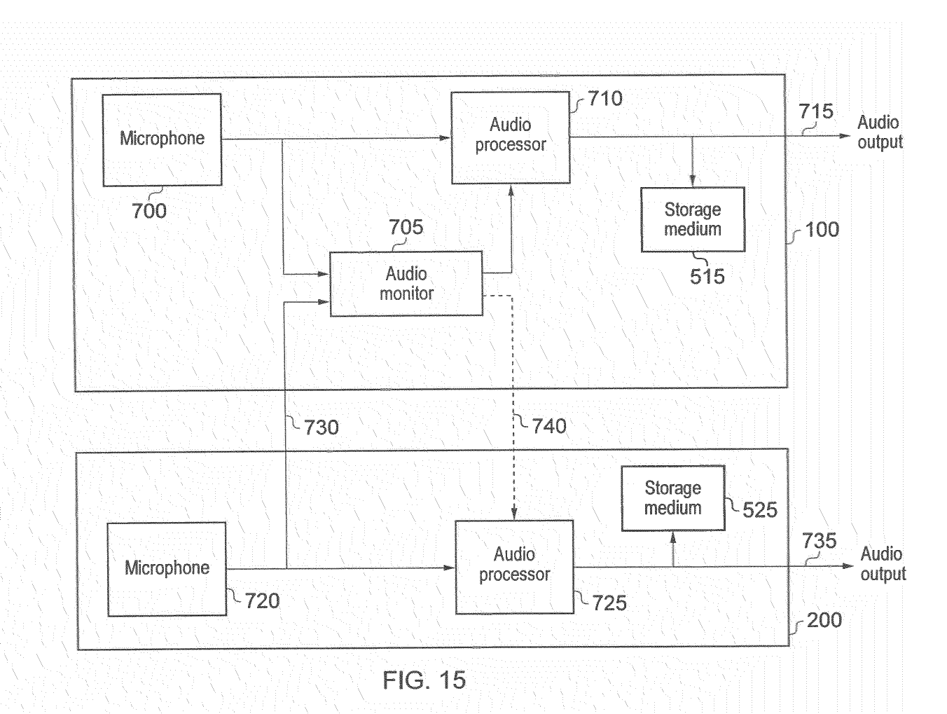

In embodiments, the second camera 200 is operable to transmit audio data to the first camera 100 via the communication link. This will now be described in more detail with reference to FIG. 15.

FIG. 15 is a schematic diagram of an arrangement of the stereo pair of video cameras for audio capture in accordance with embodiments of the present invention. In particular, FIG. 15 schematically shows the first camera 100 and the second camera 200. In the embodiment shown in FIG. 15, the first camera 100 comprises a microphone 700, an audio monitor 705, an audio processor 710 and the storage medium 515. Other elements of the first camera 100 are not shown in FIG. 15 for the sake of clarity.

The microphone 700 is operable to transmit audio signals to the audio monitor 705 and the audio processor 710. The audio monitor 705 is operable to output audio monitor signals to the audio processor 710. The audio processor 710 is operable to carry out audio processing operations on the audio signals in dependence upon the audio monitor signals and generate a first audio output stream 715. In embodiments, the camera 100 is operable to store the first audio output stream 715 to the storage medium 515 and/or output the first audio output stream via the output interface.

The second camera 200 comprises a microphone 720, an audio processor 725, and the storage medium 525. Other elements of the second camera 200 are not shown in FIG. 15 for the sake of clarity.

The microphone 720 is operable to transmit an audio signal to the audio monitor 705 of the first camera 100 via the communication link (as indicated by the arrow 730), and to the audio processor 725. In embodiments, the audio processor is operable to apply audio processing operations to the audio signal generated by the microphone 720 so as to generate a second audio output stream 735. In embodiments, the camera 200 is operable to store the second audio output stream 735 to the storage medium 525 and/or output the second audio output stream 735 via the output interface.

The audio monitor 705 is operable to monitor the audio signals from the microphone 700 and the microphone 720 and generate the audio monitor signal accordingly. For example, the audio monitor 705 could monitor the peak volume levels of the audio signal from the microphone 720 and the audio signal from the microphone 700. The audio processor 710 could then adjust the peak volume level of the audio signal from the microphone 700 so that it is the same as the peak audio level of the audio signal from the microphone 720. However, it will be appreciated that any other suitable audio processing operation could be carried out by the audio processor 710.

In some embodiments, the audio monitor 705 is operable to transmit the audio monitor signal to the audio processor 725 of the second camera 200 via the communication link as indicated by the dashed arrow 740. The audio processor 725 is operable to carry out audio processing operations on the audio signal from the microphone 720 in dependence upon the audio monitor signal received from the audio monitor 705. For example, the audio processor 725 could generate the second output audio signal 735 by adjusting the peak audio level of the audio signal from the microphone 720 so as to be the same as the peak audio level of the audio signal from the microphone 700. However, it will be appreciated that any other suitable audio processing operation could be carried out by the audio processor 725.

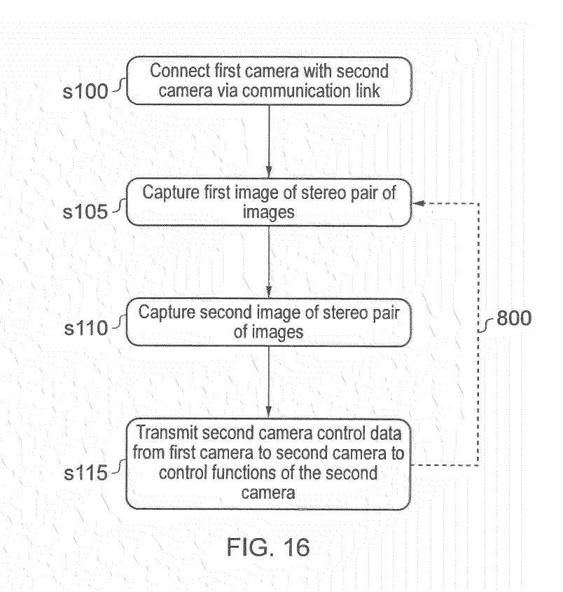

An image capturing method will now be described with reference to FIG. 16. FIG. 16 is a flow chart of an image capturing method in accordance with embodiments of the present invention.

At a step s100, the first camera 100 is connected with the second camera 200 via the communication link so that the first camera 100 can communicate with the second camera 200. In embodiments where the communication link is wired, the connecting of the cameras may take the form of the respective processors of each camera establishing the communication protocol to use. In embodiments where the communication link is a wireless link, the connecting of the cameras may comprise the respective processors of each camera establishing the wireless link, for example via a suitable handshaking protocol. However, it will be appreciated that any other suitable method of connecting the first camera 100 with the second camera 200 via the communication link may be used.

At a step s105, the first image of the stereo pair of images is captured using the first camera 100. Then, at a second step s110, the second image of the stereo pair of images is captured using the second camera 200. In embodiments, the capture of the first image and the second image occurs substantially simultaneously so that any significant motion in the captured images is captured accurately in both images. In other words, the capturing of the first image and the second image should preferably occur so that the stereo images correspond to images of the same scene at substantially the same moment in time.

At a step s115, the first camera 100 transmits second camera control data from the first camera 100 to the second camera 200 via the communication link so as to control functions of the second camera 200 which relate to the capture of the second image. For example, the first camera 100 could trigger the second camera 200 to start recording in synchrony with start of recording by the first camera 100. However, it will be appreciated that any suitable control function of the second camera 200 could be controlled by the first camera 100.

In some embodiments, the steps s105 to s115 can be looped as indicated by the dashed arrow 800. Accordingly, a left-hand media stream corresponding to a video sequence of left-hand images (e.g. first images) captured by the first camera 100 and a right-hand media stream corresponding to a video sequence of right-hand images (second images) may be generated.

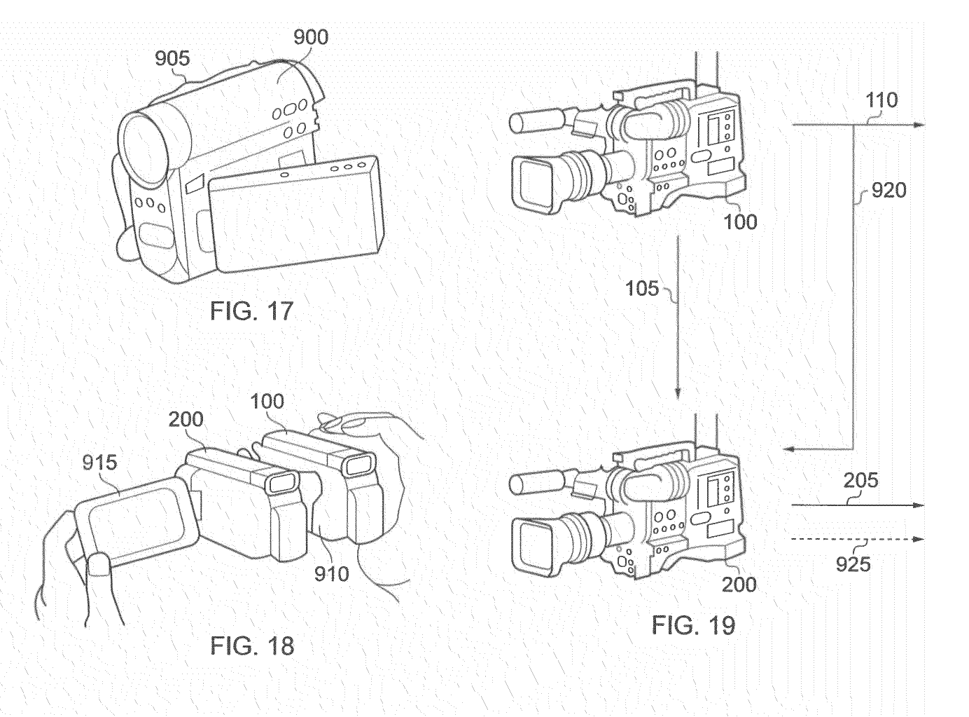

FIG. 17 is a schematic illustration of a consumer video camera 900. The consumer video camera 900 illustrated in FIG. 17 comprises user controls 905 on a right-hand side of the camera 900 and an image monitor display 910 on a left-hand side, for monitoring images captured by the camera 900. Typically, the image monitor display 910 is moveably hinged so that the image monitor display 910 can be moved so that it is flush against the camera 900 when not in use and flipped out when the display 910 is to be used to monitor images. However, if two consumer video cameras are arranged as a stereo pair of cameras, in some situations, the distance between the lens needed to capture satisfactory 3D images may mean that the image monitor display on the first camera of the pair may not be able to be used because the second camera of the pair may prevent the monitor display from being moved to the open position. This is illustrated in FIG. 18.

FIG. 18 is a schematic diagram of a stereo pair of consumer video cameras in accordance with embodiments of the present invention. In particular, FIG. 18 shows the first camera 100 and the second camera 200 of the stereo pair of cameras. In the embodiments described with respect to FIG. 18, the first camera 100 comprises a first image monitor display 910 and the second camera 200 comprises a second image monitor display 915. The first camera 100 is arranged next to the second camera 200 so that the distance between the lens of the cameras corresponds to an average distance between a typical user's eyes. The first camera 100 and the second camera 200 function in a similar manner to that described above with reference to FIGS. 1 to 16.

However, as illustrated in FIG. 18, the image monitor display 910 of the first camera 100 cannot be used because the second camera 200 is too close to the first camera 100 to allow the first image monitor display 910 to be positioned so that the user can view images displayed on the first image monitor display 910. Therefore, in embodiments, the first camera is operable to transmit the first image to the second camera via the communication link, and the second camera is operable to display at least one of the first image and the second image on the second image monitor display 915. This allows the user to monitor the images captured by the first camera 100 and/or the second camera for example, to allow the use to judge a disparity between the first image and the second image. This will now be described in more detail with reference to FIG. 19.

FIG. 19 is a schematic diagram of a fifth configuration of a stereo pair of video cameras in accordance with embodiments of the present invention.

FIG. 19 is similar to the first to fourth configurations described above. However, in the fifth configuration, the first camera 100 is operable to transmit the first image to the second camera 200 via the communication link as indicated by the arrow 920. In embodiments, the second camera 200 is operable to display the first image and/or the second image on the image monitor display of the second camera 200. In some embodiments, the second camera 200 is operable to generate camera angle setup data (as indicated by the dashed arrow 925) in a similar manner to that described above with reference to FIGS. 7 to 13.

For example, the second camera 200 could apply a red filter to the first image and a blue filter to the second image to generate a combined anachrome image. The second camera 200 could display the combined anachrome image on its image monitor display so that the user can recognise any disparity (e.g. vertical and/or horizontal) between the images and adjust the cameras accordingly. However, it will be appreciated that the second camera 200 could display the first image and/or the second image (at least one of the first image and the second image) in any suitable manner. In other words, in the embodiments described with respect to FIGS. 18 and 19, the first camera 100 is operable to control the operation of the second camera 200 but the second camera 200 is operable to display at least one of the first image and the second image so that the user can monitor the first image and/or the second image.

It will be appreciated that the elements of the first camera 100 and the second camera 200 as described above with reference to FIGS. 2 to 19 may be implemented in a video camera such as camera 10 described with respect to FIG. 1 by suitable adaptation of the elements and functional features of camera 10 as appropriate. Further more the techniques described above may be combined in any suitable manner as appropriate.

Although the capturing of images has been described with reference to capturing a stereo pair of images using two cameras, the techniques described above are more generally applicable to any number of cameras. For example, a master camera could control any suitable number of slave cameras using any of the techniques described above as appropriate, without the need for a separate control unit. In the case of a plurality of cameras, in some embodiments, the master camera is operable to select which camera(s) to control and/or select particular functions on selected cameras. Additionally, it will be appreciated that the second camera could act as the first camera and the first camera could act as the second camera as appropriate. Furthermore, the functionality described above could be distributed between the two cameras.

The various methods set out above may be implemented by adaptation of an existing image capturing device such as a video camera, for example by using a computer program product comprising processor implementable instructions stored on a data carrier such as a floppy disk, optical disk, hard disk, ROM, RAM, flash memory or any combination of these or other storage media, or transmitted via data signals on a network such as an Ethernet, a wireless network, the Internet, or any combination of these of other networks, or realised in hardware as an ASIC (application specific integrated circuit) or an FPGA (field programmable gate array) or other configurable circuit suitable to use in adapting the existing equivalent device.

In conclusion, although a variety of embodiments have been described herein, these are provided by way of example only, and many variations and modifications on such embodiments will be apparent to the skilled person and fall within the scope of the present invention, which is defined by the appended claims and their equivalents.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. An image capturing system for capturing a stereo pair of images comprising a first image and a second image, the system comprising:
a first camera operable to capture the first image of the stereo pair of images;
a second camera operable to capture the second image of the stereo pair of images;
a communication link operable to connect the first camera with the second camera so that the first camera can communicate with the second camera;
in which the first camera is operable to transmit second camera control data to the second camera via the communication link so as to control functions of the second camera which relate to the capture of the second image and in which the first camera comprises a disparity detector operable to detect a displacement between a first image feature in the first image and a corresponding second image feature in the second image.

2. A system according to claim 1, in which the first camera comprises a controller operable to: generate first camera control data associated with control functions of the first camera, the first camera control data being associated with the capture of the first image; and generate the second camera control data.

3. A system according to claim 2, in which the second camera is operable to transmit second camera status data to the first camera via the communication link, the second camera status data being indicative of a status of a control function of the second camera.

4. A system according to claim 3, in which the controller is operable to generate the second camera control data in dependence upon the second camera status data received from the second camera.

5. A system according to claim 3 or claim 4, in which:
the controller is operable to generate the first camera control data in dependence upon the second camera status data received from the second camera.

6. A system according to claim 1, in which:
the first camera comprises a first keypoint detector operable to detect a first set of one or more keypoints indicative of identifying features of the first image feature in the first image;
the second camera comprises a second keypoint detector operable to detect a second set of one or more keypoints indicative of identifying features of the second image feature of the second image;
the second camera is operable to transmit keypoint data relating to the second set of keypoints to the first camera via the communication link; and
the disparity detector is operable to detect a displacement between the first image feature and the second image feature in dependence upon a comparison between the first set of keypoints and the second set of keypoints as indicated by the keypoint data.

7. A system according to claim 1, in which:
the second camera is operable to transmit image data relating to the second image to the first camera via the communication link; and
the first camera comprises a storage element operable to store the first image and the second image based on the image data received from the second camera.

8. A system according to claim 1, in which the first image is an image from a first sequence of video images captured by the first camera, and the second image is an image from a second sequence of video images captured by the second camera.

9. A system according to claim 8, in which the first sequence of video images is associated with a first data stream representing the first sequence of video images, and the second sequence of video images is associated with a second data stream representing the second sequence of video images.

10. A system according to claim 1, in which:
the first image is associated with first audio data captured by the first camera; and
the second image is associated with second audio data captured by the second camera.

11. A system according to claim 1, in which:
the first camera is operable to transmit the first image to the second camera via the communication link; and
the second camera comprises a display operable to display at least one of the first image and the second image.

12. An image capturing apparatus for capturing a stereo pair of images comprising a first image and a second image, the apparatus comprising:
an image capturing element operable to capture the first image of the stereo pair of images;
a communication interface operable to receive, from a second camera, the second image of the stereo pair of images via a communication link; and
a controller operable to generate second camera control data associated with control functions of the second camera which relate to the capture of the second image,
in which the image capturing apparatus is operable to transmit the second camera control data to the second camera via the communication link so as to control the functions of the second camera which relate to the capture of the second image and a disparity detector operable to detect a displacement between a first image feature in the first image and a corresponding second image feature in the second image.

13. An image capturing apparatus for capturing a first image of a stereo pair of images comprising the first image and a second image, the apparatus comprising:
an image capturing element operable to capture the first image of the stereo pair of images; and
a communication interface operable to transmit the first image of the stereo pair of images to a second camera via a communication link, the second image being associated with the second camera;
in which:
the communication interface is operable to receive, from the second camera via the communication link, camera control data associated with control functions of the image processing apparatus which relate to the capture of the first image; and
the image capturing apparatus is operable to capture the first image in dependence upon the camera control data received from the second camera and to detect a displacement between a first image feature in the first image and a corresponding second image feature in the second image.

14. An image capturing apparatus according to claim 13, comprising:
a keypoint detector operable to detect a set of one or more keypoints indicative of identifying features of an image feature in the first image,
in which the communication interface is operable to transmit keypoint data relating to the set of keypoints to the first camera via the communication link.

15. An image capturing method for capturing a stereo pair of images comprising a first image and a second image, the method comprising:
connecting a first camera with a second camera via a communication link so that the first camera can communicate with the second camera;
capturing, at the first camera, the first image of the stereo pair of images;
capturing, at the second camera, the second image of the stereo pair of images;
transmitting second camera control data from the first camera to the second camera via the communication link so as to control functions of the second camera which relate to the capture of the second image, and
detecting a displacement between a first image feature in the first image and a corresponding second image feature in the second image.

16. A computer program for implementing the method of claim 15.

17. A storage medium configured to store the computer program of claim 16 therein or thereon.
